(19) United States
(12) Patent Application Publication
(10) Pub. No.: US 2024/0140759 A1
(43) Pub. Date: May 2, 2024

(54) SYSTEMS AND METHOD FOR DETECTING A LOCATION OF A PERSON IN A HOISTWAY

(71) Applicant: OTIS ELEVATOR COMPANY, Farmington, CT (US)

(72) Inventors: Appalaraju Marpu, Hyderabad (IN); Malleswara Reddy Gutti, Hyderabad (IN); Stefan Ey, Berlin (DE); Javier Muñoz Sotoca, Rivas-Vaciamadrid (ES); Luis Mena, Getafe (ES); Peter Herkel, Berlin (DE); Jan Ruhnke, Berlin (DE); Felix Donath, Berlin (DE); Colette Ruden, West Hartford, CT (US); Randy Roberts, Hebron, CT (US); Craig Drew Bogli, Avon, CT (US); Johanna Whitwell, Hartford, CT (US); Mustapha Toutaoui, Berlin (DE); Sylvain Kabre, Poitiers (FR)

(21) Appl. No.: 17/990,844

(22) Filed: Nov. 21, 2022

(30) Foreign Application Priority Data
Oct. 28, 2022 (IN) 202211061502

(51) Int. Cl. B66B 5/00; B66B 1/34

(52) U.S. Cl. CPC B66B 5/0062; B66B 1/3461

(57) ABSTRACT

Disclosed is an elevator system, including a hoistway; an elevator car in the hoistway; sensors in the hoistway operationally coupled to the elevator car and configured to capture sensor data indicative of a person being in the hoistway, and a processor configured to determine from the sensor data that the person is in the hoistway; and wherein the elevator car is configured to reduce speed or stop when the processor determines the person is in the hoistway.

### CROSS-REFERENCE TO RELATED APPLICATIONS

This application claims the benefit of Indian Patent Application number 202211061502 filed Oct. 28, 2022, which is incorporated herein by reference in its entirety.

### BACKGROUND

The embodiments relate to an elevator system and more specifically to systems and method for detecting a location of a person in a hoistway.

Safety of a mechanic in the field in elevator systems, or any person that may be in an elevator hoistway, is a concern of the elevator industry. Though rules and protocols are in place to protect mechanics, there remain instances where mechanics may not follow the safety protocols and therefore become injured. There is a desire to provide a solution which assists in protecting the safety of mechanics in the field.

### BRIEF SUMMARY

Disclosed is an elevator system, including a hoistway; an elevator car in the hoistway; sensors in the hoistway operationally coupled to the elevator car and configured to capture sensor data indicative of a person being in the hoistway, and a processor configured to determine from the sensor data that the person is in the hoistway; and wherein the elevator car is configured to reduce speed or stop when the processor determines the person is in the hoistway.

In addition to one or more aspects of the system, or as an alternate, the processor is one or more of: the sensors configured for edge computing; an elevator controller operationally coupled to the elevator car and communicatively coupled to the sensors; or a cloud service communicatively coupled to one or more of the elevator controller and the sensors.

In addition to one or more aspects of the system, or as an alternate, the processor is configured to transmit an alert when the sensor data is indicative of the person in the hoistway.

In addition to one or more aspects of the system, or as an alternate, the sensors are located at one or more of a top of the elevator car, a bottom of the elevator car, a top of the hoistway, within a hoistway pit, and on or adjacent to a ladder of the hoistway pit.

In addition to one or more aspects of the system, or as an alternate, the sensors are one or more of cameras, LIDAR sensors, temperature sensors and volumetric detectors, nmWave radar and thermal cameras.

In addition to one or more aspects of the system, or as an alternate, the processor is configured to compare captured sensor data from the sensors with previously obtained data representing the hoistway without the person therein to determine whether the person is within the hoistway.

In addition to one or more aspects of the system, or as an alternate, the captured data and the previously obtained data are each two or three dimensional representations of the hoistway.

In addition to one or more aspects of the system, or as an alternate, the sensors are LIDAR sensors located at or more of the top of the elevator car and within a hoistway pit and are configured to generate a sensing curtain to determine a presence of the person.

In addition to one or more aspects of the system, or as an alternate, the sensors include a volumetric detector in a hoistway pit and a laser projector or light projector in the hoistway pit, configured to project a predetermined image on the floor of the hoistway pit, the image representing a predefined emergency position, and wherein the laser is configured to display the predefined emergency position for a person detected in the hoistway pit and the processor is configured to determine from data captured by the volumetric detector whether the person is in the predefined emergency position.

In addition to one or more aspects of the system, or as an alternate, the sensors are automatically actuated when the elevator car is controlled to move.

In addition to one or more aspects of the system, or as an alternate, the elevator controller is configured to operate in a normal mode, and the elevator controller stops the elevator car upon rendering a determination that the person is in the hoistway.

In addition to one or more aspects of the system, or as an alternate, the elevator controller is configured to operate in an inspection mode, whereby and the elevator controller is configured to run the elevator car at a reduced speed regardless of the determination that the person is in the hoistway.

In addition to one or more aspects of the system, or as an alternate, the inspection mode is a top of car inspection mode.

Further disclosed is a method of controlling an elevator car in a hoistway, including capture sensor data from sensors representing the hoistway when the elevator car moves in the hoistway; analyzing the data via a processor to determine if a person is in the hoistway; and stopping or reducing speed of the elevator car when the person is in the hoistway.

In addition to one or more aspects of the method, or as an alternate, the processor is one or more of: the sensors configured for edge computing; an elevator controller operationally coupled to the elevator car and communicatively coupled to the sensors; or a cloud service communicatively coupled to one or more of the elevator controller and the sensors.

In addition to one or more aspects of the method, or as an alternate, the method includes controlling the elevator car to move upwardly or downwardly in the hoistway; determining from the sensor data a distance and speed toward an object in the hoistway; determining whether the object is the person; and depending on the distance to the object and speed of the elevator car, stopping or reducing speed of the elevator car upon determining that the object is the person.

In addition to one or more aspects of the method, or as an alternate, the method includes determining whether the object is the person by communication with a tag configured for telecommunications and located in the hoistway and associated with the person.

In addition to one or more aspects of the method, or as an alternate, the method includes determining, by the elevator controller, that the elevator controller is in a normal run mode; and permitting, by the elevator controller, the elevator car to run only a determination is rendered that the person is not detected within the hoistway.

In addition to one or more aspects of the method, or as an alternate, the method includes determining, by the elevator controller, that the elevator controller is in an inspection mode; and permitting, by the elevator controller, the elevator car to run regardless of whether the determination is rendered by the that the person is within the hoistway.

In addition to one or more aspects of the method, or as an alternate, determining, by the elevator controller, that the elevator controller is in the inspection mode includes determining that the elevator controller is in a top of car inspection mode.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2A shows system that includes sensors to determine if a mechanic is in the hoistway;

FIG. 2B is a flowchart showing a method of identifying a mechanic in a hoistway;

FIG. 2C shows the implementation of time-of-flight cameras below and/or above an elevator car that detect a mechanic in a hoistway according to an embodiment;

FIG. 2D shows a pre-calculated 3D model of the hoistway without a mechanic or obstacles in it;

FIG. 2E shows a 3D model of the hoistway, calculated from current conditions (e.g., a live-calculated 3D model), without a mechanic or obstacles in it;

FIG. 3A shows an elevator car with a LIDAR sensor mounted to the top and bottom of the car, according to another embodiment;

FIG. 3B shows a method of detecting a mechanic in a hoistway utilizing LIDAR sensors;

FIG. 3C shows elevator cars sensing a mechanic in a hoistway utilizing LIDAR sensors;

FIG. 3D shows a location of LIDAR sensors above and below the elevator car;

FIG. 3E shows a LIDAR sensor sensing a mechanic in its field of view on a pit ladder, according to an embodiment;

FIG. 3F shows a graph of a response for the LIDAR sensor that changes when a mechanic is on a pit ladder;

FIG. 3G shows the implementation of a pair of LIDAR sensors located in opposite corners of an elevator pit to detect the presence of a mechanic, according to an embodiment;

FIG. 3H shows a mechanic in the LIDAR sensor detection field in the elevator pit;

FIG. 4A shows a thermal sensor on top of an elevator car;

FIG. 4B shows a flow chart for detecting, with heat sensors, that a mechanic is on the elevator car and confirming whether the car is operating in a normal speed mode or in an inspection speed mode during this time;

FIG. 5 shows a system for detecting a mechanic's presence and also indicating whether the mechanic is in a safety position utilizing a volumetric space detector according to an embodiment;

FIG. 6A shows a mechanic at an elevator shaft door above the elevator car with a camera above the elevator car detecting the mechanic, with no danger conditions detected as the mechanic is not entering the hoistway;

FIG. 6B shows a mechanic at an elevator shaft door below the elevator car with a camera below the elevator car detecting the mechanic, with no danger conditions detected as the mechanic is not entering the hoistway;

FIG. 6C shows mechanics at elevator shaft doors above and below the elevator car with cameras above and below the elevator car detecting the mechanics, with no danger conditions detected as the mechanics are not entering the hoistway;

FIG. 6D shows mechanics at elevator shaft doors above and below the elevator car with cameras above and below the elevator car detecting the mechanics, with a danger condition detected below the elevator car as one of the mechanics is in the pit and in the way of the direction of travel of the elevator car; and

FIG. 6E shows mechanics at elevator shaft doors above and below the elevator car with cameras above and below the elevator car detecting the mechanics, with a danger condition detected above the elevator car as the mechanic is at least partially enters the hoistway.

### DETAILED DESCRIPTION

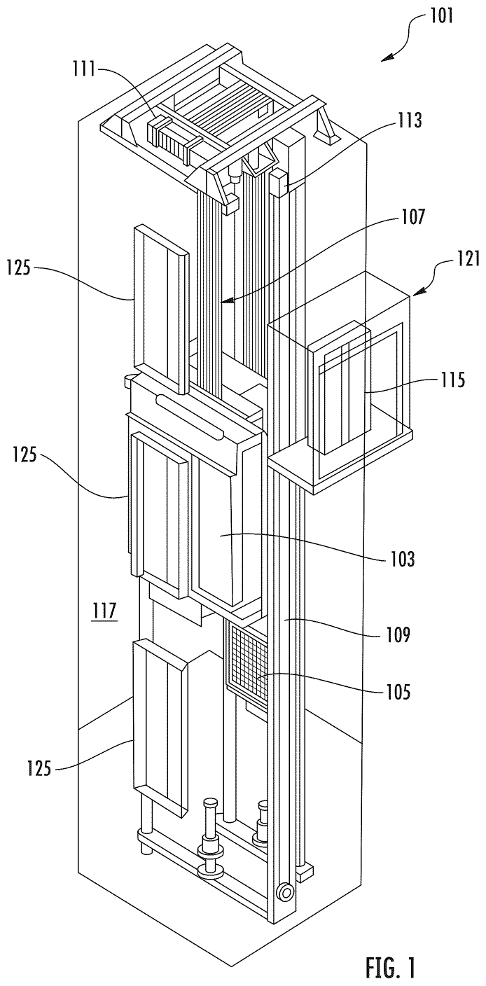

FIG. 1 is a perspective view of an elevator system 101 including an elevator car 103, a counterweight 105, a tension member 107, a guide rail (or rail system) 109, a machine (or machine system) 111, a position reference system 113, and an electronic elevator controller (controller) 115, which may include on-site electronics that perform processing for safety functions and control functions for the elevator car 103. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft (or hoistway) 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 or in a separate machine room (not shown) and is configured to control the operation of the elevator system 101, and particularly the elevator car 103. For example, the controller 115 may provide drive signals to the machine 111 to control the acceleration, deceleration, leveling, stopping, etc., of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. As disclosed in greater detail below, the controller 115 can apply a brake on the machine 111 or elevator car 103 to stop the car 103 if humans are detected, e.g., in the shaft 117. Although shown in a controller room 121, those of skill in the art will appreciate that the controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. Embodiments may also be employed in ropeless elevator systems using self-propelled elevator cars (e.g., elevator cars equipped with friction wheels, pinch wheels or traction wheels). FIG. 1 is merely a non-limiting example presented for illustrative and explanatory purposes.

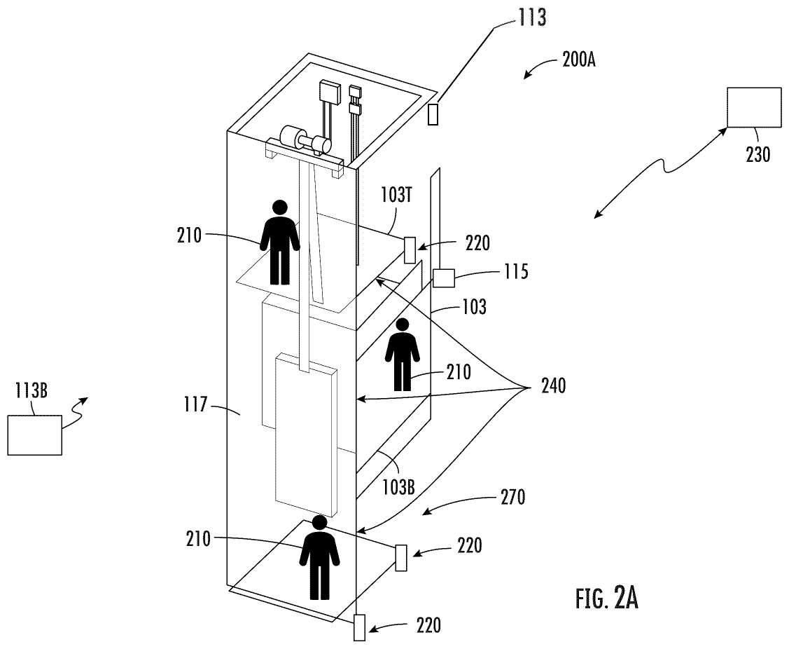

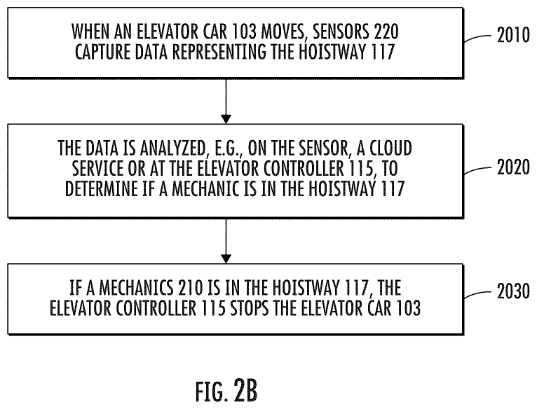

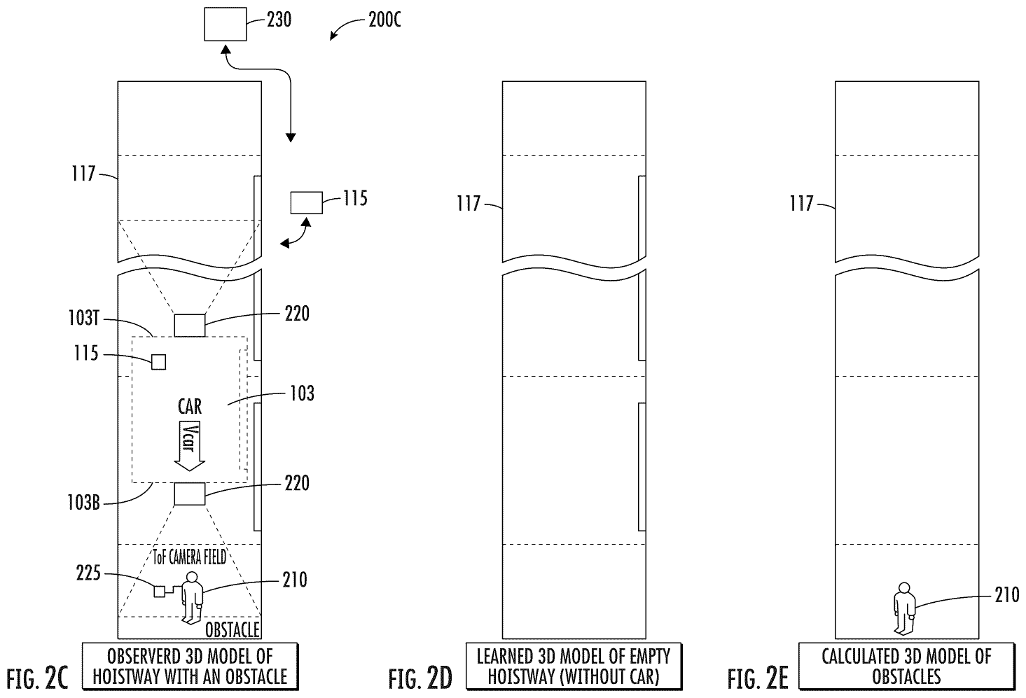

Turning to FIGS. 2A and 2B, according to an embodiment, the system 200A is configured to automatically stop an elevator car 103 from moving and provide safety to mechanics 210 in a hoistway 117 using deep learning and machine learning by the elevator controller 115. All systems such as 101 and 200A disclosed herein differ only to the extent identified and in some embodiments may include all features identified among two or more of the systems to provide for redundant features that identify a mechanic 210 in a hoistway 117.

When a group of mechanics 210 enter the hoistway 117 or a car 103 for inspection purposes, or for fixing issues either within the hoistway 117 or the car 103, if the mechanics are not appropriately following required safety procedures there is a chance that the group may lose track of one of the mechanics 210 and return the elevator car 103 from an inspection mode to a run mode while one of the mechanics 210 is in the hoistway 117. This may lead to one of the mechanics 210 becoming trapped and potentially injured. According to embodiments, using machine learning and related cognitive services by the elevator controller 115, the system of the embodiments is configured to automatically detect the mechanic 210 in the hoistway when car moves.

For example, multiple mechanics 210 may enter a hoistway 117 and a car 103. The mechanics 210 may initiate fixing the car 103 and hoistway 117 issues, e.g., simultaneously. While one or more of the mechanics 210 may be in the hoistway 117, one of the mechanics 210 in the car 103 may accidentally control the car 103 to move. According to the embodiment, sensors 220 such as cameras in the hoistway 117 and attached to car 103 automatically start capturing images of hoistway 117, e.g., when the car 103 starts moving. The cameras 220 may send captured sensor data such as images to a cloud service 230 or may process the images utilizing edge computing, or the controller 115 may process the images, or processing may occur among these processing implements. The processing may include cognitive services and deep learning analyses to determine whether a mechanic 210 is in the hoistway 117. If there is a determination that the mechanic 210 is in the hoistway 117, then an alert may be sent to the elevator controller 115 to stop the car 103, or the controller 115 may stop the car 103 if it was the implement performing the analysis. An alert may be communicated to all mechanics 210 automatically identifying the incident and the exact location of mechanic 210 in the hoistway 117. In one embodiment the sensor 220 is radar. The sensors 220 may be able to monitor discrete areas 240 in the hoistway 117 so several sensors 220 may be utilized including above the top 103T and below 103B the car 103 and in the hoistway pit 270. Also shown in FIG. 2A is the position reference system 113, which is utilized to create the hoistway model (discussed below).

In addition to or as an alternate to machine learning, the embodiments could utilize a heart-beat communication for this process to ensure the reliability of the communications and the timeliness of the response. This is because determinations provided by the disclosed embodiments may need to be performed rapidly, such as under two seconds, which may limit the time available for communicating with a remote service such as a cloud.

The embodiments may provide a mitigation safety issues when mechanics do not follow required safety procedures safer working environment for mechanics 210 in an elevator system. Car 103 and hoistway 117 mounted cameras 220 may provide coverage of the hoistway 210. Such images may be processed on the camera 220 via edge computing or AI cognitive services may be used to determine if any mechanic 210 is in the hoistway 117. This may occur before allowing the elevator controller 115 to move the car 103.

FIG. 2B shows a process of determining that a mechanic 210 is in the hoistway 117. As shown in block 2010, when an elevator car 103 moves, sensors 220 such as cameras, capture data such as images of the hoistway 117. As shown in block 2020, the data is analyzed, e.g., on the sensor 220, a cloud service 230 or at the elevator controller 115 by applying deep learning or machine learning, to determine if a mechanic is in the hoistway 117. Such analysis may include learning the ambient background expected by a sensor with no mechanics around, extracting any differences in sensor readings from the learned ambient background, and sensing a relative motion of any extracted differences to provide a robust indication of mechanics in the environment.

As shown in block 2030, if a mechanic 210 is in the hoistway 117, the elevator controller 115 stops or reduces speed of the elevator car 103. If the elevator controller 115 does not perform the processing then the processor, e.g., on the sensor 220 or cloud service 230, alerts the controller 115 to stop. Otherwise, the controller 115 make the determination to stop the car 103. An alert may be communicated to all mechanics 210.

Turning to FIGS. 2C-2E, another system 200C is illustrated that is directed to collision detection in the path in real time based on a learned 3D model, corresponding to a learned ambient background, and live 3D sensor data from sensors such as 3D cameras 220 or Time-of-Flight sensors mounted to a top and bottom 103T, 103B of the elevator car 103 in the hoistway 117. It is to be appreciated that reference to 3D models and sensors configured for capturing 3D sensor data is not intended on limiting the scope of the embodiments. Mechanics must never enter the hoistway when an elevator car is moving, however if a mechanic fails to follow the required safety procedures an elevator car 103 that is in motion may not be able to determine when and where an obstacle such as a mechanic 210 may appear. For example the mechanic 210 may be in the pit 270. Because mechanics are not allowed to enter the pit when the elevator is in motion an elevator system may only have data based on how the environment in the hoistway 117 is structured without any mechanic 210 or obstacle in the path. The system 200C is configured to compare an expected clean (e.g., from previously obtained data) environment for the hoistway 117, which is learned individually for each installed car 103/hoistway 117 combination, i.e., a clean state, with a current unknown environment in real-time, i.e., a current state, and make determinations based on the comparison. More specifically, a set of 3D data of the hoistway 117 environment, that is prepared in advance, is obtained by the sensor 220, controller 115, cloud computing service 230, or combination thereof. Starting with this initial data from the sensor 220, data of a current state the hoistway 117 path, above the top 103T and below the bottom 103B of the elevator car 103, is learned during or before the processing of a handover of the elevator car 103 from a mechanic 210 that was servicing the elevator car 103 or the hoistway 117. The current state data, shown in FIG. 2C, may be captured by sensors including cameras 220, which may be time of flight (ToF) cameras, or other sensors capable of sensing an environment (e.g. LIDAR, RADAR, infrared) and a difference in the data observed in the environment above and below the car 103 is analyzed by the sensor 220, controller 115, cloud computing service 230, or combination thereof. This is accomplished by comparing the current state with a pre-learned state of the empty hoistway 117, shown in FIG. 2D to produce differential data shown in FIG. 2E of detected foreign objects such as a mechanic 210 in the hoistway 117. The elevator controller 115 receives alerts in real-time if there is an object, such as a mechanic 210, detected in the hoistway 117. It is to be appreciated that the embodiments may also be applied on the counterweight as it also is moving and can cause injury to mechanics who are not following the required safety procedures.

The elevator controller 115, sensor 220, cloud service 230, or combination thereof are programmed to determine in real time whether to bring the elevator car 103 to a safe, normal operating state, depending on the objects identified in the hoistway 117, including object type, e.g., mechanic 210 vs stationary object, the object's size and location. The set of available responses, depending on a complexity of the system, can be characterized as smart responses, such as providing warning audio and/or a visual signal, allowing motion of the elevator car in the opposite direction, allowing continued motion of the elevator car at a reduced speed, and alternatively stopping the car. The motion state of the elevator car (i.e., position and velocity) may be part of that decision process. The position reference system 113 (FIG. 1) could provide the sensor input for the determination of the smart responses. In some embodiments, where the position reference system 113 is used to decide the smart responses, the position reference system 113 could operate independently of the normal means of control and a supplemental position reference system 113B (FIG. 2A), which could be independent of position reference system 113, could be provided. The supplemental position reference system 113B may include a supplemental sensor that is utilized to obtain a reference state in which no person is within a travel path of the elevator car in the hoistway.

The system 200C may be able to determine if an object is a mechanic 210 by visual detection sensors 220 or other sensors such as sensors for reading an RFID employee tags 225 or tags that are otherwise configured with telecommunications capabilities, such as Bluetooth Low Energy (BLE). The computing units, e.g., implemented on an FPGA (Field-Programmable Gate Arrays) platform, could perform the data processing in real-time.

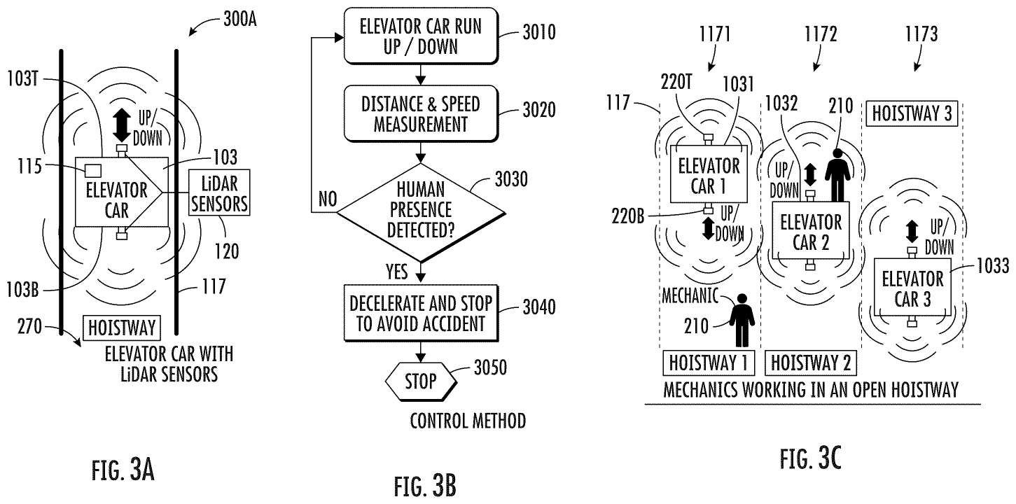

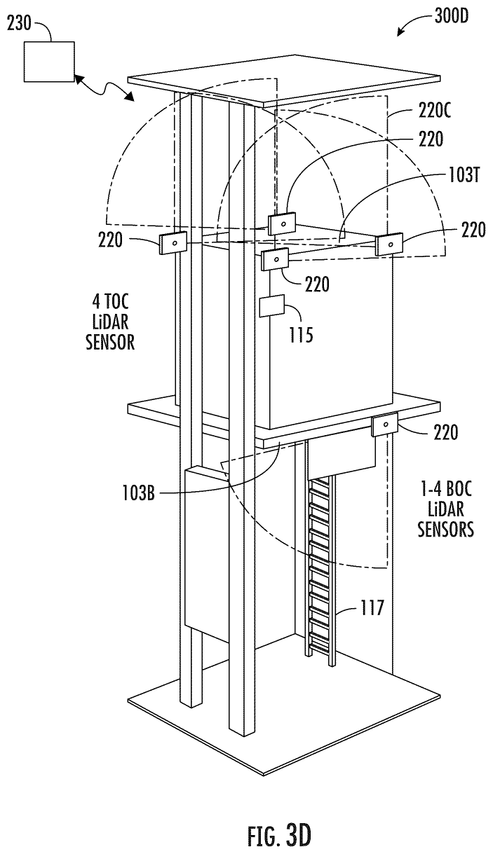

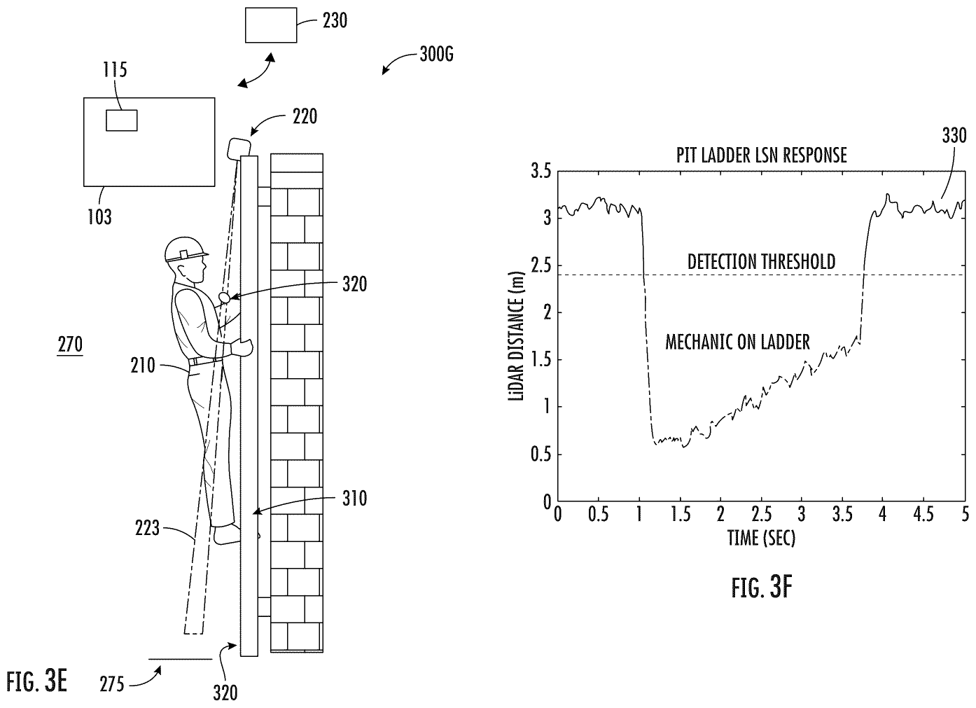

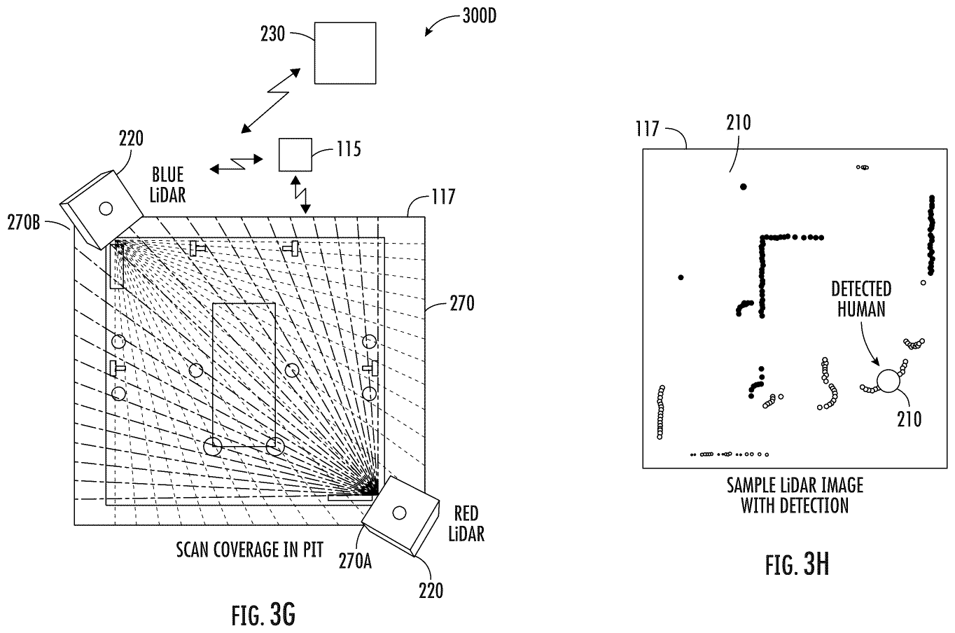

Turning to FIGS. 3A-3C, according to another disclosed system 300A, an elevator car 103 utilizes LIDAR (Light Detection And Ranging) sensors 220 to detect a mechanic's 210 presence and prevent an accident. LIDAR sensors 220 may be mounted on the top and bottom 103T, 103B of the car 103 for obtaining optical distance and speed measurement, as shown in FIG. 3A. According to the disclosed method, shown in FIG. 3B, at block 3010 the elevator car 103 runs up or down. At block 3020 a distance to surrounding objects and speed measurements are obtained using the LIDAR sensors 220. It is to be appreciated that block 3020 is optional. At block 3030, a determination is made as to whether the LIDAR data identifies a mechanic 210 in the hoistway 117. This determination is made on the sensor 220 via edge computing or on the cloud service 230 or elevator controller 115, or combination thereto. In case of an obstacle detection (yes at block 3030), e.g., a mechanic 210 that is not following required safety procedures and is working on top 103T of the car 103, on top of the hoistway 117 or in the pit 270, as shown in block 3040, the car 103 via the controller 115, depending on the distance to the person and the speed of the car 103, will automatically reduce its speed before stopping, or stop the car 103, as shown in block 3050, to avoid a collision. As indicated above, smart responses, depending on a complexity of the system, include providing warning audio and/or a visual signal, allowing motion of the elevator car in the opposite direction, allowing continued motion of the elevator car at a reduced speed, and stopping the car. The motion state of the elevator car (i.e., position and velocity) may be part of that decision process. As indicated, the position reference system 113 (FIG. 1) could provide the sensor input for the smart decision. Where the position reference system 113 is used to decide the smart responses, the position reference system 113 would operate independently of the normal means of control and the supplemental position reference system 113B (FIG. 2A), which would be independent of position reference system 113, would be provided.

As shown in FIG. 3C, in some cases where hoistways 117 have multiple cars 1031, 1032, 1033 in respective car lanes 1171, 1172, 1173, the LIDAR sensors 220T, 220B on a car top and bottom 103T, 103B in one lane may detect the presence of a mechanic 210 who is not following the required safety procedures is in an adjacent lane. From this, the elevator car 103 in the appropriate lane may reduce its speed, and stop as necessary to an avoid accident. Benefits of the embodiments include protecting mechanics who are not following the required safety procedures 210 during their work on top 103T of the car 103, in the hoistway 117. The methodology may work independently of the existing control system utilized in an elevator system. This inferred control approach may utilize a higher level of integrated control and sensor sharing between the hoistways. Each car could have a self-sufficient safety system that only relies on its sensed data or alternatively the safety system could share data from the multiple cars. Shared and coordinated safety controls are within the scope of the embodiments.

Turning to FIG. 3D, another disclosed system 300D includes LIDAR sensors 220 located at strategic locations along the top 103T and bottom 103B of the car 103. Four ninety-degree LIDAR sensors 220 may be mounted on opposing four corners of the top 103T of the car 103 and may be configured to generate a sensing curtain 220C sensing the penetration of an obstruction, e.g., a body part, that reaches beyond an acceptable threshold during car 103 operation in either a normal or inspection mode. Additionally, depending on the hoistway 117 layout, LIDAR sensors 220 may be mounted on opposing corners of the bottom 103B of the car 103 that would detect the presence of an obstruction past the projection of the car 103, e.g., a mechanic 210 leaning out from a spreader beam or leaning in from a landing. The LIDAR sensor 220, utilizing edge computing, or in communication with a cloud service 230 or an elevator controller 115, or a combination thereof, may determine the distance of any detected obstruction within a set range and trigger an emergency stop of the elevator car 103 via the car controller 115. The embodiments may reduce otherwise concerning safety risks for mechanics 210 who are not following the required safety procedures and are operating in the hoistway 117. The TOF (LiDAR) sensors can be 2D or 3D, and they can be located at various locations on TOC (top of car) and BOC (bottom of car). As an alternative to the configuration shown in FIG. 3D, single 3D sensor, multiple 3D sensors, or a combination 3D and 2D sensors arrangement are within the scope of the embodiments. The embodiment illustrated in FIG. 3D can be utilized to detect when, and prevent harm to, mechanics that are on top of the car lean over the handrails, and are thus putting themselves in harms-way.

Turning to FIG. 3E, another system 300E include a LIDAR sensor 220 disposed on an elevator pit ladder 310. It may be desirable to control an elevator car 103 such that all movement of the car 103 is prevented when a mechanic 210 is on a pit ladder 310. The embodiments provide a LIDAR sensor 220 aligned with a vertical axis 320 of the ladder 310 or slightly skewed thereto. The sensor 220 can be a narrow view angle device, e.g., configured to sense within a two (2) degree field, so as to sense when a mechanic 210 is on the pit ladder 310 and not following the required safety procedures. The LIDAR sensor 210, using e.g., edge computing, the elevator controller 115, a cloud service 230, or combination thereof, can read a distance between its location and any object in its beam 223 path. A mechanic 210 on the ladder 310, as illustrated, may break the beam 223, resulting in a shorter distance than a nominal value when the beam 223 reaches the floor 275 of the pit 270. Other sensors with the scope of the embodiments include nmWave radar, PIR (passive infrared sensor) sensors, and thermal cameras.

The graph of FIG. 3F shows how the sensed reflected beam 223 distance 330 for the sensor 220 will change when a mechanic 210 is on the ladder 310. The time axis indicates elapsed time where the mechanic walks down the ladder, which takes about three seconds in the illustrated example. A detection distance threshold, as illustrated in the graph, may then be used by the sensor 220, the elevator controller 115 or a cloud service 230, or combination thereof, to detect the presence of a mechanic 210 on the ladder 310. The embodiments provide a retrofittable solution that does not require significant modifications to an existing pit ladders 210.

Turning to FIGS. 3G and 3H, another system 300G includes a pair of LIDAR sensors 220 in the pit 270 that are configured to detect an unexpected stationary or moving object such as a mechanic 210 in the pit 270 at any given time. The sensors 220 may be solid state 2-D sensors having +/−45 degree field view with a 0.75 degree resolution. The sensors 220 may be integrated with the elevator safety chain to prevent car 103 and counterweight 105 movement and/or create an audible alert to mechanics 210 in the hoistway 117. The embodiments provide a pair of LIDAR sensors 220 positioned on opposing corners 270A, 270B of a same plane in a pit 270 of a hoistway 117 to view of all obstacles in the pit 270. Post processing of the data, which may occur via edge computing on the LIDAR sensors 220, a cloud service 230 or on a car controller 115, or combination thereof, provides a baseline view of the pit area 270. Any obstacles such as a mechanic 210 who is not following the required safety procedures can be detected by real-time post processing of LIDAR sensor 200 measurements. The sensor 220 can have a view angle device of approximately four (4) degrees to sense when a mechanic 210 is, for example, on the pit ladder 310 (FIG. 3E) or otherwise in the pit 270. By having a pair of LIDAR sensors 220 on opposite corners 270A, 270B of the pit 270, a higher degree of resolution may provide the data necessary to detect any changes. The combined imaging of the pit 270 will be able to provide the location of the mechanic 210 in the pit and cause a break in the safety chain to stop car 103 and counterweight 105 (FIG. 1) movement. FIG. 3G shows the field of view that the sensors 220 have when imaging a pit area 270. FIG. 3H shows the field with mechanic detected therein. The LIDAR sensor 220 setup can improve safety for mechanics 210 in the pit 270 who are not following the required safety procedures to ensure the controller 115 is aware of the location of the mechanic 210 when the mechanic is in the field of movement of the car 103 and counterweight 105. Once integrated into the safety chain, the system 300G, configured with the LIDAR sensors 220, is configured to stop movement of the car 103 if, for example, a second mechanic 210 is not aware of the situation or does not react in time. As an alternative to the configuration shown in FIG. 3G, the scope of the embodiments includes 3D sensors at a higher elevation (for example, six feet) directed downwardly, toward the pit floor.

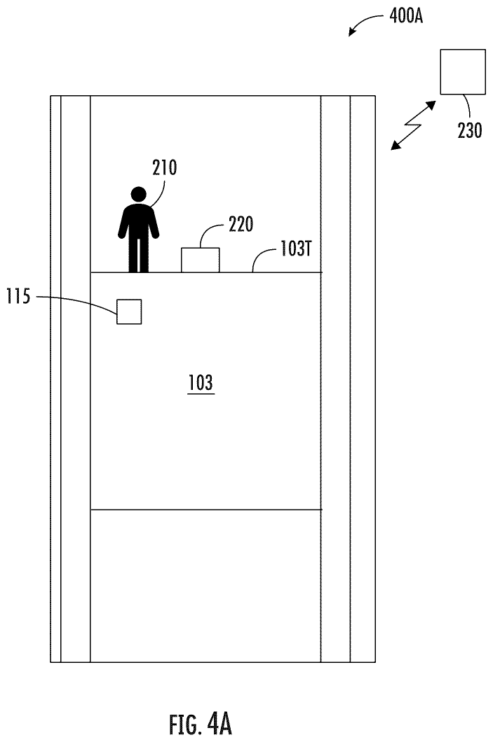

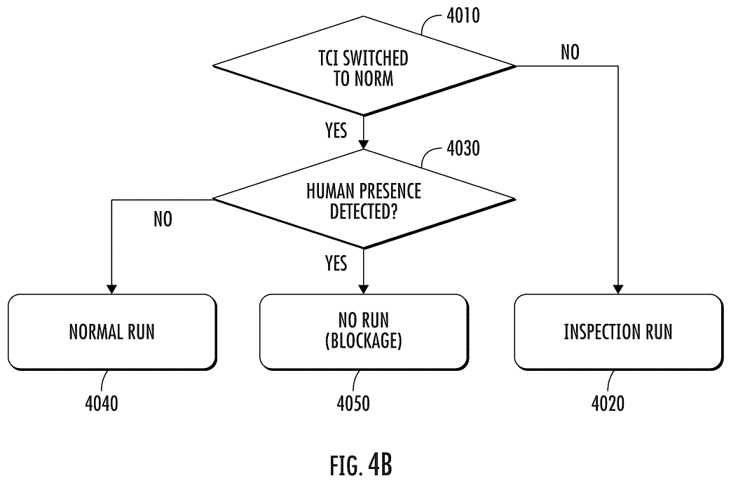

Turning to FIGS. 4A and 4B, another disclosed system 400A includes a sensor 220, which may be a thermal sensor, for protecting a mechanic 210 working on the top 103T of the car 103 and who is not following the required safety procedures. For a mechanic 210 on the top 103T of the car 103, in case of new installation or component replacement in the hoistway 117 or other maintenance, the mechanic 210 moves the elevator car 103 to different location in the hoistway (e.g., different stops) to perform the required tasks. While the mechanic should run the car 103 at low speeds during this process, the mechanic 210 not following the required safety procedures may not do so. Accordingly, the embodiments are directed to mounting the thermal sensor 220 on the top 103T of the car 103 to continuously detect the surrounding temperature. Based on the temperature, there may be a determination, e.g., via edge computing on the sensor 220, the cloud service 230 or on the car controller 115, or a combination thereof, that a mechanic 210 is present. The sensor 2220 may be continuously active and connected to the car controller 115 which supervises the elevator functions.

The controller 115 may operate in a normal mode in which the car 103 may travel at normal speeds, or in an inspection mode in which the car 103 may travel at a slower speed, which is deemed safe for the mechanic 210 to perform work. As shown in Table 1, below, when the TCI (Top of Car Inspection) is not switched by the mechanic to the “INS” (inspection) position (or mode), i.e., the car 103 stays in the “NORM” (normal) position (or mode), and at the same time the sensor 220 provides the information of a mechanic 210 presence, the car controller 115 will not allow the car 103 to run. The mechanic 210 is thereby required to switch to “INS” (inspection) Position (mode) to move the car 103 and to continue his work.

TABLE 1
Top of Car Inspection (TCI)

| TCI | Sensor | Car Run Status |
|---|---|---|
| Norm | Human Detected | No Run (Blockage) |
| Norm | No detection | Normal run is allowed |
| INS | Indifferent | Inspection Run Is Allowed |

As shown in FIG. 4B, the disclosed process starts with block 4010 in which the controller 115 determines whether the Top Of Car inspection mode is normal or inspection. If it is in an inspection mode (yes at 4010), then the controller 115 the controller will allow the car 103 to run as indicated in block 4020. If it is switched to a normal mode (yes at 4010) then at block 4030 a further determination is made as to whether a mechanic 210 is detected via the temperature sensor 400. If a mechanic 210 is not detected (no at 4030) then the elevator car 103 is controlled by the controller 115 to run at normal speed as indicated in block 4040. If a mechanic is detected (yes at 4030) then the elevator car 103 is controlled by the controller 115 to not run as indicated in block 4050. As indicated above, smart responses, depending on a complexity of the system, include providing warning audio and/or a visual signal, allowing motion of the elevator car in the opposite direction, allowing continued motion of the elevator car at a reduced speed, and stopping the car. The motion state of the elevator car (i.e., position and velocity) may be part of that decision process. As indicated, the position reference system 113 (FIG. 1) could provide the sensor input for the smart decision. Where the position reference system 113 is used to decide the smart responses, the position reference system 113 would operate independently of the normal means of control and the supplemental position reference system 113B (FIG. 2A), which would be independent of position reference system 113, would be provided.

Benefits of the embodiments include safe maintenance by a mechanic 210 on top of car 103T. The embodiments may operate independently of the existing car control system.

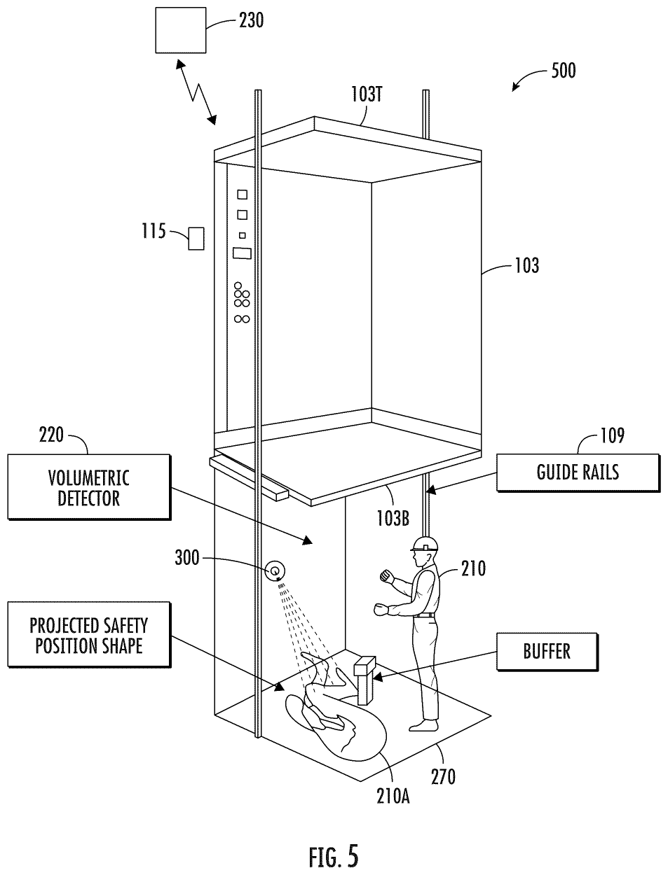

Turning to FIG. 5, another disclosed system 500 is configured to detect whether a mechanic 210 is in an emergency position in a hoistway 117 utilizing a volumetric space detector 220. In a case of an unintended movement of the car 103, while a mechanic 210 is working in the pit 270 or the top 103T of the car 103, the mechanic 210 should lay in a predetermined specific position depending on the elevator 103 model, size, etc., in order to avoid being trapped between the car 103 and the hoistway 117. The position could be learned for each elevator type to avoid injury. If the volumetric sensor detects a person, the light projector may project a shape with the predetermined area/position. The shape may be a square, a circle, or a crouching position. The embodiments help the mechanic, for example, who may not remember or know the safety position, by showing them with the projection. The embodiments provide for installing a sensor 220 in the form of a volumetric space detector within the elevator pit 270, configured to detect a mechanic 210 working and stop the car 103 upon detecting the same. A laser projector 300 may project a shape 210A into the pit 270. With the projected shape, the sensor 220, or the elevator car controller 115, a cloud service 230 or combination thereof (collectively and alternatively referred to as a processor), may determine whether the mechanic 210 is in the predefined emergency position.

In one embodiment, the utilization of the laser detection scheme is controlled by the GCB (group control board) and actuated when the KS contact is activated and there is risk of entrapment. A KS is known switch at each landing door lock. If a door is open by the mechanic, the switch can provide a signal to a general control board to stop the car or to activate an inspection mode.

The laser projector 300 can be located on the car bottom 103B or along the hoistway 117. The laser projector 300 could be a laser pointer with a tip with a shape cut-out or a regular light with a shade screen of this shape. In one embodiment, for an on-top hoistway 117 implementation, the embodiments can be applied at the car top (e.g., from the ceiling) 103T, by similarly installing a volumetric detector and a light projector there. The embodiments provide for increasing safety for mechanics and related personnel.

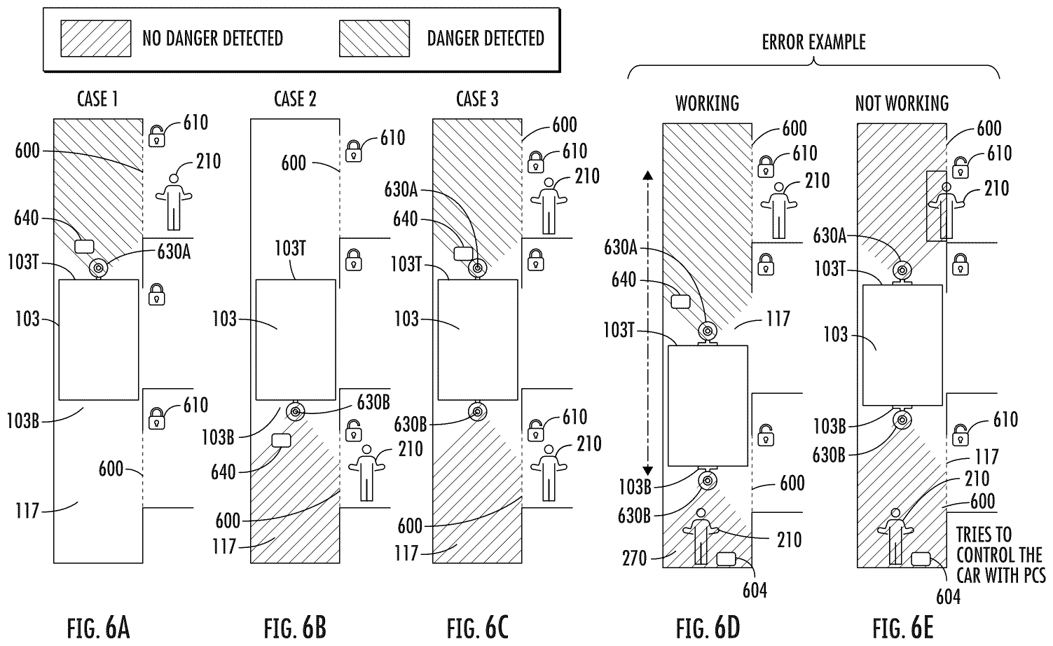

Turning to FIGS. 6A-6E, a further embodiment is also directed to detection of a mechanic 210 in a hoistway 117. Unlocking a landing door 600 activates a security system 610, such as by triggering a switch at the landing door 600. The system 610 would include cameras 630, e.g., one camera 630A on (operationally connected to) the top 103T and one camera 630B on the bottom 103B of the car 103. If the landing door 600 is unlocked, depending on the position and/or direction of motion of the car 103, the top or the bottom camera 630A, 630B activates. If at least two landing doors 600 are open and one is above the car 103 and the other one is below the car 103, then both cameras 630A/630B may activate. When a landing door 600 is unlocked, the camera 630 detects the presence of the mechanic 210 utilizing software, which may be processed via edge computing for the camera 630 or via a processor 640 to which the camera 630 is operationally connected. The camera 630 or processor 640 could identify an area of risk for a mechanic 210 in the hoistway 117 and the car 103 would not be able to move until those areas are clear. Internet of Thing (JOT), e.g., processing camera data via a cloud service 230 (FIG. 5) is within the scope of the embodiments.

For example, FIG. 6A shows a mechanic 210 at an elevator shaft door 600 above the elevator car 103 with a camera 630A above the elevator car 103 detecting the mechanic 210. No danger conditions detected as the mechanic 210 is not entering the hoistway 117, e.g., within a risk area in the hoistway 117. FIG. 6B shows a mechanic 210 at an elevator shaft door 600 below the elevator car 103 with a camera 630 below the elevator car 103 detecting the mechanic 210. No danger condition is detected as the mechanic 210 is not entering the hoistway 117. FIG. 6C shows mechanics 210 at elevator shaft doors 600 above and below the elevator car 103 with cameras 630A/630B above and below the elevator car 103 detecting the mechanics 210. No danger conditions are detected as the mechanics 210 are not entering the hoistway 117. FIG. 6D shows mechanics 210 at elevator shaft doors 600 above and below the elevator car 103 with cameras 630A/630B above and below the elevator car 103 detecting the mechanics 210. A danger condition is detected below the elevator car 103 as one of the mechanics 210 is in the pit 270 and in the way of the direction of travel of the elevator car 103. FIG. 6E shows mechanics 210 at elevator shaft doors 600 above and below the elevator car 103 with cameras 630A/603B above and below the elevator car 103 detecting the mechanics 210. A danger condition is detected above the elevator car 103 as one of the mechanics 210 at least partially enters the hoistway 117 so that the mechanic is in the way of the direction of travel of the elevator car 103.

For the hoistway learning concepts identified above, e.g., directed to learning ambient background from cameras or 3D sensors, a vertical location reference, e.g., the position reference sensor 113, may be utilized. In addition, there are many operational modes that could be called “stopping” the elevator car. For example: (a) a controlled motion profile to the next committable floor; (b) a controlled deceleration which could bring the car to a stop at a non-landing floor; and (c) an emergency stop using the machine/motor brakes. The elevator controller 115 can apply all of these options which includes controlling to the extent required, the mechanical brakes.

In the above embodiments, sensor data may be obtained and processed separately, or simultaneously and stitched together, or a combination thereof, and may be processed in a raw or complied form. The sensor data may be processed on the sensor (e.g. via edge computing), by controllers identified or implicated herein, on a cloud service, or by a combination of one or more of these computing systems. The sensor may communicate the data via wired or wireless transmission lines, applying one or more protocols as indicated below.

Wireless connections may apply protocols that include local area network (LAN, or WLAN for wireless LAN) protocols. LAN protocols include WiFi technology, based on the Section 802.11 standards from the Institute of Electrical and Electronics Engineers (IEEE). Other applicable protocols include Low Power WAN (LPWAN), which is a wireless wide area network (WAN) designed to allow long-range communications at a low bit rates, to enable end devices to operate for extended periods of time (years) using battery power. Long Range WAN (LoRaWAN) is one type of LPWAN maintained by the LoRa Alliance, and is a media access control (MAC) layer protocol for transferring management and application messages between a network server and application server, respectively. LAN and WAN protocols may be generally considered TCP/IP protocols (transmission control protocol/Internet protocol), used to govern the connection of computer systems to the Internet. Wireless connections may also apply protocols that include private area network (PAN) protocols. PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

Wireless connections may also include radio-frequency identification (RFID) technology, used for communicating with an integrated chip (IC), e.g., on an RFID smartcard. In addition, Sub-1 Ghz RF equipment operates in the ISM (industrial, scientific and medical) spectrum bands below Sub 1 Ghz-typically in the 769-935 MHz, 315 Mhz and the 468 Mhz frequency range. This spectrum band below 1 Ghz is particularly useful for RF IOT (internet of things) applications. The Internet of things (IoT) describes the network of physical objects—“things”—that are embedded with sensors, software, and other technologies for the purpose of connecting and exchanging data with other devices and systems over the Internet. Other LPWAN-IOT technologies include narrowband internet of things (NB-IOT) and Category M1 internet of things (Cat M1-IOT). Wireless communications for the disclosed systems may include cellular, e.g. 2G/3G/4G (etc.). Other wireless platforms based on RFID technologies include Near-Field-Communication (NFC), which is a set of communication protocols for low-speed communications, e.g., to exchange date between electronic devices over a short distance. NFC standards are defined by the ISO/IEC (defined below), the NFC Forum and the GSMA (Global System for Mobile Communications) group. The above is not intended on limiting the scope of applicable wireless technologies.

Wired connections may include connections (cables/interfaces) under RS (recommended standard)-422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a master/slave protocol designed for use with its programmable logic controllers (PLCs) and which is a commonly available means of connecting industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Controller Area Network (CAN) bus. A CAN is a vehicle bus standard that allow microcontrollers and devices to communicate with each other in applications without a host computer. CAN is a message-based protocol released by the International Organization for Standards (ISO). The above is not intended on limiting the scope of applicable wired technologies, which may include, and not be limited to, USB and Ethernet (or POE—Power Over Ethernet), as non-limiting examples.

When data is transmitted over a network between end processors as identified herein, the data may be transmitted in raw form or may be processed in whole or part at any one of the end processors or an intermediate processor, e.g., at a cloud service (e.g. where at least a portion of the transmission path is wireless) or other processor. The data may be parsed at any one of the processors, partially or completely processed or complied, and may then be stitched together or maintained as separate packets of information. Each processor or controller identified herein may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory identified herein may be but is not limited to a random access memory (RAM), read only memory (ROM), or other electronic, optical, magnetic or any other computer readable medium.

The controller may further include, in addition to a processor and non-volatile memory, one or more input and/or output (I/O) device interface(s) that are communicatively coupled via an onboard (local) interface to communicate among other devices. The onboard interface may include, for example but not limited to, an onboard system bus, including a control bus (for inter-device communications), an address bus (for physical addressing) and a data bus (for transferring data). That is, the system bus may enable the electronic communications between the processor, memory and I/O connections. The I/O connections may also include wired connections and/or wireless connections identified herein. The onboard interface may have additional elements, which are omitted for simplicity, such as controllers, buffers (caches), drivers, repeaters, and receivers to enable electronic communications. The memory may execute programs, access data, or lookup charts, or a combination of each, in furtherance of its processing, all of which may be stored in advance or received during execution of its processes by other computing devices, e.g., via a cloud service or other network connection identified herein with other processors.

Embodiments can be in the form of processor-implemented processes and devices for practicing those processes, such as processor. Embodiments can also be in the form of computer code based modules, e.g., computer program code (e.g., computer program product) containing instructions embodied in tangible media (e.g., non-transitory computer readable medium), such as floppy diskettes, CD ROMs, hard drives, on processor registers as firmware, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes a device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator system, comprising:
a hoistway;
an elevator car in the hoistway;
sensors in the hoistway operationally coupled to the elevator car and configured to capture sensor data indicative of a person being in the hoistway, and
a processor configured to determine from the sensor data that the person is in the hoistway; and
wherein the elevator car is configured to reduce speed or stop when the processor determines the person is in the hoistway.

2. The system of claim 1, wherein:
the processor is one or more of:
the sensors configured for edge computing;
an elevator controller operationally coupled to the elevator car and communicatively coupled to the sensors; or
a cloud service communicatively coupled to one or more of the elevator controller and the sensors.

3. The system of claim 2, wherein
the processor is configured to transmit an alert when the sensor data is indicative of the person in the hoistway.

4. The system of claim 2, wherein
the sensors are located at one or more of a top of the elevator car, a bottom of the elevator car, a top of the hoistway, within a hoistway pit, and on or adjacent to a ladder of the hoistway pit.

5. The system of claim 2, wherein the sensors are one or more of cameras, LIDAR sensors, temperature sensors and volumetric detectors, nmWave radar and thermal cameras.

6. The system of claim 2, wherein the processor is configured to compare captured sensor data from the sensors with previously obtained data representing the hoistway without the person therein to determine whether the person is within the hoistway.

7. The system of claim 6, wherein the captured data and the previously obtained data are each two or three dimensional representations of the hoistway.

8. The system of claim 2, wherein the sensors are LIDAR sensors located at or more of the top of the elevator car and within a hoistway pit and are configured to generate a sensing curtain to determine a presence of the person.

9. The system of claim 2, wherein the sensors include a volumetric detector in a hoistway pit and a laser projector or light projector in the hoistway pit, configured to project a predetermined image on the floor of the hoistway pit, the image representing a predefined emergency position, and wherein the laser is configured to display the predefined emergency position for a person detected in the hoistway pit and the processor is configured to determine from data captured by the volumetric detector whether the person is in the predefined emergency position.

10. The system of claim 2, wherein the sensors are automatically actuated when the elevator car is controlled to move.

11. The system of claim 2, wherein the elevator controller is configured to operate in a normal mode, and the elevator controller stops the elevator car upon rendering a determination that the person is in the hoistway.

12. The system of claim 11, wherein the elevator controller is configured to operate in an inspection mode, whereby and the elevator controller is configured to run the elevator car at a reduced speed regardless of the determination that the person is in the hoistway.

13. The system of claim 12, wherein the inspection mode is a top of car inspection mode.

14. A method of controlling an elevator car in a hoistway, comprising:
capture sensor data from sensors representing the hoistway when the elevator car moves in the hoistway;
analyzing the data via a processor to determine if a person is in the hoistway; and
stopping or reducing speed of the elevator car when the person is in the hoistway.

15. The method of claim 14, wherein
the processor is one or more of:
the sensors configured for edge computing;
an elevator controller operationally coupled to the elevator car and communicatively coupled to the sensors; or
a cloud service communicatively coupled to one or more of the elevator controller and the sensors.

16. The method of claim 15, comprising:
controlling the elevator car to move upwardly or downwardly in the hoistway;
determining from the sensor data a distance and speed toward an object in the hoistway;
determining whether the object is the person; and
depending on the distance to the object and speed of the elevator car, stopping or reducing speed of the elevator car upon determining that the object is the person.

17. The method claim 16, wherein a supplemental position reference system includes a supplemental sensor that is utilized to obtain a reference state in which no person is within a travel path of the elevator car in the hoistway.

18. The method of claim 16, including:
determining whether the object is the person by communication with a tag configured for telecommunications and located in the hoistway and associated with the person.

19. The method of claim 15, comprising:
determining, by the elevator controller, that the elevator controller is in a normal run mode; and
permitting, by the elevator controller, the elevator car to run only a determination is rendered that the person is not detected within the hoistway.

20. The method of claim 18, comprising:
determining, by the elevator controller, that the elevator controller is in an inspection mode; and
permitting, by the elevator controller, the elevator car to run regardless of whether the determination is rendered by the that the person is within the hoistway.
